(19) United States
(12) Patent Application Publication
(10) Pub. No.: US 2012/0318242 A1
(43) Pub. Date: Dec. 20, 2012

(54) PURGE CONTROL SOLENOID VALVE FOR REDUCING NOISE

(75) Inventors: Dong Gwan ROH, Hwaseong-si (KR); Cha Sub Lim, Suwon-si (KR)

(73) Assignee: Hyundai Motor Company, Seoul (KR)

(21) Appl. No.: 13/316,526

(22) Filed: Dec. 11, 2011

(30) Foreign Application Priority Data
Jun. 20, 2011 (KR) 10-2011-0059545

(51) Int. Cl. F02M 33/02

(52) U.S. Cl. 123/520

(57) ABSTRACT

A purge control solenoid valve apparatus for reducing noise, may include a valve housing having an upper connector and a lower connector to be in communication with each other in upper and lower parts thereof and a plunger for opening the upper connector when the plunger receives a magnetic force, and a chamber housing including a canister connector connected to a canister through an evaporation hose and an expansion space part expandably connecting the canister connector and the lower connector.

### CROSS-REFERENCE TO RELATED APPLICATION

The present application claims priority to Korean Patent Application No. 10-2011-0059545 filed the entire contents of which is incorporated herein for all purposes by this reference.

### BACKGROUND OF THE INVENTION

1. Field of the Invention

The present invention relates to a purge control solenoid valve, and more particularly, to a purge control solenoid valve for reducing noise by preventing vibration from being generated through damping pulsating pressure.

2. Background Art

In general, a purge control solenoid valve (PCSV) is a valve that is positioned between a suction manifold and a canister and controls fuel evaporation gas collected in the canister.

Gasoline fuel evaporation gas generated from a fuel tank is collected in the canister and the purge control solenoid valve is actuated according to judgment of an ECU that collects information from each of sensors (a water temperature sensor and an oxygen sensor) to allow the collected gas to flow in a surge tank to be combusted, thereby preventing hazardous gas from being discharged to the atmosphere.

As shown in FIG. 1A, the purge control solenoid valve in the related art includes an upper housing 10 having a laval nozzle 12, a lower housing 14 having a connector 16, a solenoid port 18 installed in the lower housing 14, a solenoid core 20 placed at the center of the solenoid port 18, a coil 22 placed while covering the solenoid core 20, a spring 24 compressibly inserted into the center of the solenoid core 20, and a plunger 28 integrally formed on the top outer periphery of the solenoid core 20 to be elevatable with a diaphragm 26 interposed therebetween.

That is, when an ECU (not shown) applies a current signal to the coil 22 mounted in the purge control solenoid valve with the actuation of an engine, current alternately flows and stops in the coil 22, such that a magnetic field is generated around the coil 22 and when magnetic force is generated from the solenoid core 20, the plunger 28 contacts the solenoid core 20 while compressing the spring 24. As a result, as the plunger 28 moves down, the laval nozzle 12 of the lower housing 14 is opened and the fuel evaporation gas flows to the engine.

However, as shown in FIG. 1B, in the case of the purge control solenoid valve (PCSV) 100 in the related art, the fuel evaporation gas collected in the canister 200 is supplied through a steam hose and noise due to scattering of the evaporation gas is generated from an inner wall of the steam hose 300 while the fuel evaporation gas moves in the steam hose 300. In particular, the noise is even larger at a bending point of the steam hose 300 in a vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a purge control solenoid valve for reducing noise that can reduce a reverberation sound by vehicle vibration by damping pulsating pressure.

In one aspect, a purge control solenoid valve apparatus for reducing noise may include a valve housing having an upper connector and a lower connector to be in communication with each other in upper and lower parts thereof and a plunger for opening the upper connector when the plunger receives a magnetic force, and a chamber housing including a canister connector connected to a canister through an evaporation hose and an expansion space part expandably connecting the canister connector and the lower connector.

The purge control solenoid valve apparatus for reducing noise may further include a solenoid core placed in the valve housing between the lower connector and the upper connector and having a mounting groove at an inner center thereof, a coil placed to surround an outer part of the solenoid core in the valve housing, an elastic spring inserted into the mounting groove of the solenoid core, a plunger elevatably connected to a top outer periphery of the solenoid core with a diaphragm interposed therebetween and elastically supported by the elastic spring.

The lower connector is inserted into the expansion space part to protrude in the expansion space part, wherein the canister connector of the chamber housing and the lower connector of the valve housing are placed to offset each other.

The canister connector of the chamber housing and the lower connector of the valve housing are placed to offset each other or placed on the same line.

The chamber housing is integrally provided in a lower part of the valve housing

A plurality of partitions having through-holes are placed to be separated from each other in the expansion space part, wherein the expansion space part is constituted by a plurality of expansion space portions divided by the plurality of partitions.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a side cross-sectional view showing a purge control solenoid valve in the related art.

FIG. 1B is a state diagram showing a connection state between the purge control solenoid valve in the related art and a canister.

FIG. 2 is a side cross-sectional view showing a purge control solenoid valve according to a various exemplary embodiments of the present invention.

FIG. 3 is a side cross-sectional view showing a purge control solenoid valve according to a various exemplary embodiments of the present invention.

FIG. 4 is a side cross-sectional view showing a purge control solenoid valve according to a various exemplary embodiments of the present invention.

FIG. 5 is a side cross-sectional view showing a purge control solenoid valve according to a various exemplary embodiments of the present invention.

FIG. 6 is a graph showing transmission loss of noise depending on a change in diameter of a chamber according to an exemplary embodiment of the present invention.

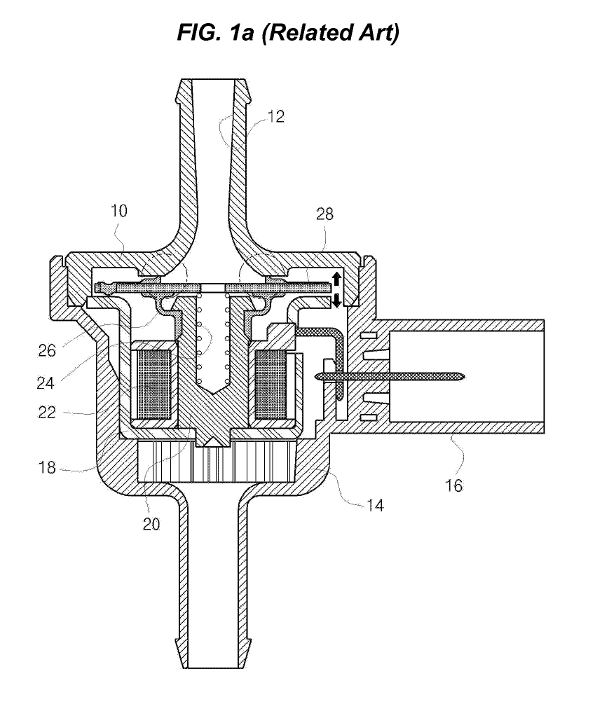

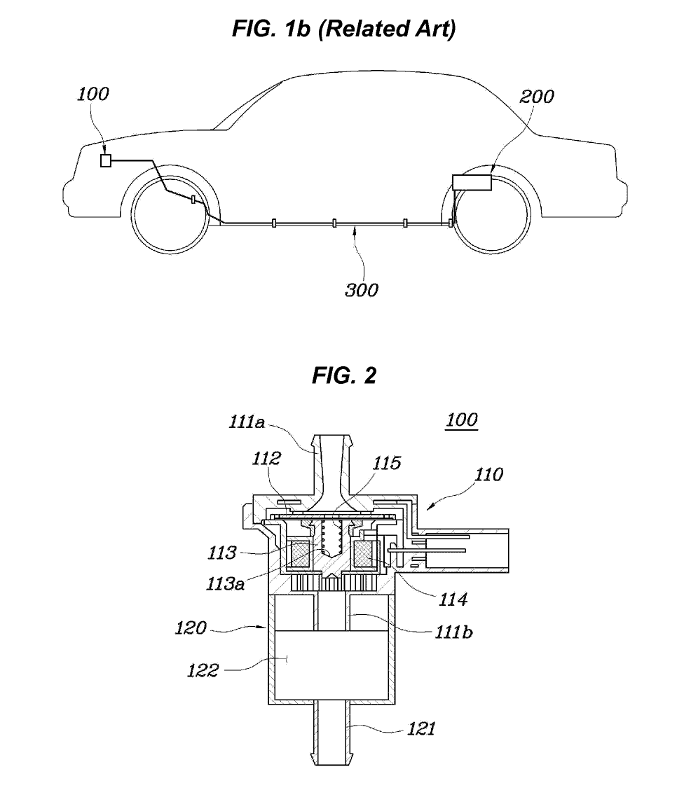

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

An exemplary embodiment of the present invention will be described in detail with reference to the accompanying drawings.

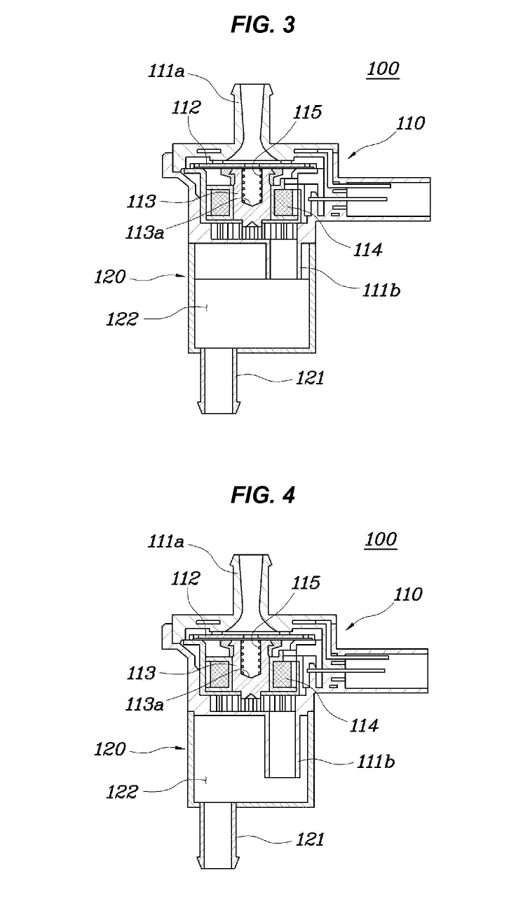

FIG. 2 is a side cross-sectional view showing a purge control solenoid valve according to a first exemplary embodiment of the present invention, FIG. 3 is a side cross-sectional view showing a purge control solenoid valve according to a second exemplary embodiment of the present invention, and FIG. 4 is a side cross-sectional view showing a purge control solenoid valve according to a third exemplary embodiment of the present invention.

As shown in FIG. 2, the purge control solenoid valve includes a valve housing 110 controlling fuel evaporation gas of a canister 200 and a chamber housing 120 reducing pulsating vibration from the fuel evaporation gas that flows in from the valve housing 110.

Specifically, in the valve housing 110 as a housing positioned between a suction manifold and the canister 200, an upper connector 111a connected with the suction manifold is formed in a lower part thereof and a lower connector 111b connected with the chamber housing 120 is formed in a lower part thereof.

A valve component that controls the fuel evaporation gas of the canister 200 is mounted on the valve housing 110. The valve component used in the exemplary embodiment includes a solenoid core 113, a coil 114, an elastic spring 115, a diaphragm, and a plunger 112. Herein, since the constitution of the solenoid core 113, the coil 114, the elastic spring 115, the diaphragm, and the plunger 112 is the same as the constitution of a core, a coil, an elastic spring, and a plunger used in a purge control solenoid valve in the related art, a detailed description thereof will be omitted.

However, in the exemplary embodiment, the solenoid core 113 as a structure in which magnetic force is generated by a magnetic field of the coil 114 is placed at the center of the valve housing 110 and has a mounting groove 113a mounted with the elastic spring 115 inside thereof The coil 114 is placed to surround the outer part of the solenoid core 113 to form the magnetic field when receiving a current signal. The elastic spring 115 is inserted into the mounting groove 113a of the solenoid core 113 to elastically support the plunger 112. The plunger 112 is elevatably connected to the top outer periphery of the solenoid core 113 with the diaphragm interposed therebetween to press the elastic spring 115 while moving down when the magnetic force is generated.

Therefore, when the current signal is applied, the magnetic field is generated around the coil 114 and when the magnetic force is generated in the solenoid core 113, the plunger 112 contacts the solenoid core 113 while compressing the elastic spring 115 and as the plunger 112 moved down, the upper connector 111a is opened to open a laval nozzle 12, and as a result, the fuel evaporation gas flows toward an engine where there is the suction manifold.

The chamber housing 120 connected to the lower connector 111b is integrally coupled to the valve housing 110.

The chamber housing 120 provides a pipe-expanding structure with respect to the evaporation gas that flows in the valve housing 110 to reduce the pulsating vibration to the fuel evaporation gas. That is, a canister connector 121 connected to the canister 200 through an evaporation hose 300 is provided below the chamber housing 120 and an expansion space part 122 connecting the canister connector 121 and the lower connector 111b is provided above the chamber housing 120.

In particular, the expansion space part 122 is constituted by a chamber having a diameter larger than the diameter of the canister connector 121. Since pressure variation with respect to a frequency of the evaporation gas can be reduced in the expanded chamber, noise caused due to the pulsating vibration of the fuel evaporation gas can be reduced. In this case, when the frequency of the fuel evaporation gas is low, the volume of the chamber in the expansion space part 122 is preferably large.

In the first exemplary embodiment, the canister connector 121 of the chamber housing 120 and the lower connector 111b of the valve housing 110 are placed on the same line, but as shown in FIG. 3, in the second exemplary embodiment of the present invention, the canister connector 121 of the chamber housing 120 and the lower connector 111b of the valve housing 110 may be placed to offset each other.

Further, as shown in FIG. 4, according to the third exemplary embodiment, the lower connector 111b of the valve housing 110 is inserted into the expansion space part 122 to protrude in the expansion space part 122. In an exemplary embodiment of the present invention, the canister connector 121 of the chamber housing 120 and the lower connector 111b of the valve housing 110 are placed to offset each other or placed on the same line.

The structure of the chamber housing 120 according to the first to third exemplary embodiments is preferably selected and used in an appropriate manner by considering a damping amount of the pulsating pressure of the evaporation gas or tuning of a damping frequency.

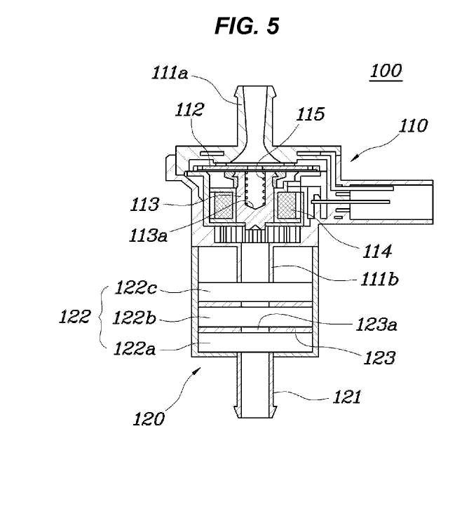

FIG. 5 is a side cross-sectional view showing a purge control solenoid valve according to a fourth exemplary embodiment of the present invention.

As shown in FIG. 5, according to the fourth exemplary embodiment, a plurality of partitions 123 may be provided in the expansion space part 122. The plurality of partitions 123 have through-holes 123a where the evaporation gas moves and are placed to be separated from each other in upward and downward directions of the chamber housing 120.

For example, when two partitions 123 are installed in the expansion space part 122, the expansion space part 122 may be divided into a first expansion space portion 122a, a second expansion space portion 122b, and a third expansion space portion 122c. In this case, the evaporation gas that flows in through the canister connector 121 is subjected to three damping operations while passing through the first to third expansion space portions 122a, 122b, and 122c to thereby reduce the vibration of the fuel evaporation gas effectively.

For reference, transmission loss of noise depending on the diameter of the chamber will be described below.

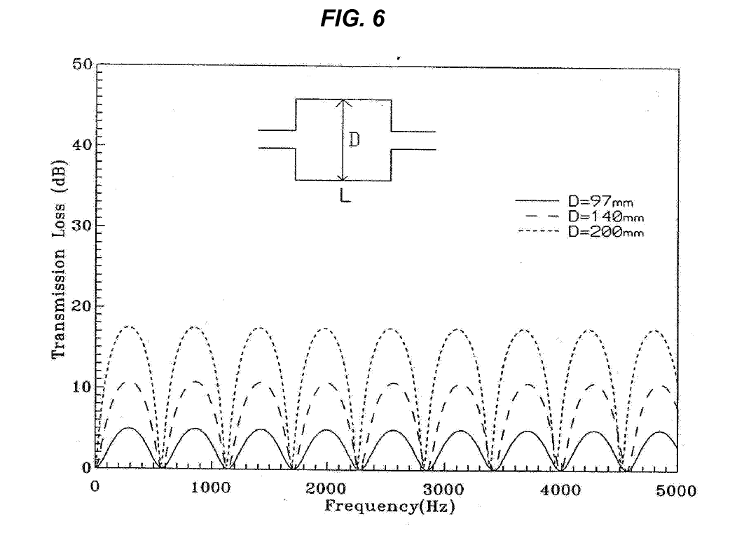

FIG. 6 is a graph showing transmission loss of noise depending on a change in diameter of a chamber according to an exemplary embodiment of the present invention.

As shown in FIG. 6, the diameter of the chamber is set to 97 mm, 140 mm, and 200 mm and in this case, the length of the chamber is set to 300 mm and the diameters of an inlet and an outlet of the chamber are set to 54 mm.

According to a result of experimentation regarding the transmission loss of the noise depending on the diameter, it can be seen that as the diameter of the chamber becomes larger, the variation of the transmission loss is measured to be larger.

As set forth above, the present invention has excellent advantages in that NVH merchantability can be improved by reducing a reverberation noise in a room of a vehicle transferred to a vehicle body due to vibration force caused by the pulsating pressure through the expansion space part in the chamber housing and by integrally configuring a valve housing and a chamber housing, a manufacturing cost can be reduced through the decrease in the number of components.

According to an exemplary embodiment of the present invention, the following remarkable effects can be achieved.

First, according to an exemplary embodiment of the present invention, when pulsating pressure is generated from a steam hose with the actuation of a purge control solenoid valve, NVH merchantability can be improved by reducing a reverberation noise in a room of a vehicle transferred to a vehicle body due to vibration force caused by the pulsating pressure.

Second, according to the exemplary embodiment of the present invention, since an additional component for reducing noise does not need to be installed in a steam hose or a fuel line by integrally configuring a valve housing and a chamber housing, a manufacturing cost can be saved through the decrease in the number of components.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A purge control solenoid valve apparatus for reducing noise, comprising:
a valve housing having an upper connector and a lower connector to be in communication with each other in upper and lower parts thereof and a plunger for opening the upper connector when the plunger receives a magnetic force; and
a chamber housing including a canister connector connected to a canister through an evaporation hose and an expansion space part expandably connecting the canister connector and the lower connector.

2. The purge control solenoid valve apparatus for reducing noise as defined in claim 1, further including:
a solenoid core placed in the valve housing between the lower connector and the upper connector and having a mounting groove at an inner center thereof;
a coil placed to surround an outer part of the solenoid core in the valve housing;
an elastic spring inserted into the mounting groove of the solenoid core;
a plunger elevatably connected to a top outer periphery of the solenoid core with a diaphragm interposed therebetween and elastically supported by the elastic spring.

3. The purge control solenoid valve apparatus for reducing noise as defined in claim 1, wherein the lower connector is inserted into the expansion space part to protrude in the expansion space part.

4. The purge control solenoid valve apparatus for reducing noise as defined in claim 3, wherein the canister connector of the chamber housing and the lower connector of the valve housing are placed to offset each other.

5. The purge control solenoid valve apparatus for reducing noise as defined in claim 1, wherein the canister connector of the chamber housing and the lower connector of the valve housing are placed to offset each other or placed on the same line.

6. The purge control solenoid valve apparatus for reducing noise as defined in claim 1, wherein the chamber housing is integrally provided in a lower part of the valve housing.

7. The purge control solenoid valve apparatus for reducing noise as defined in claim 1, wherein a plurality of partitions having through-holes are placed to be separated from each other in the expansion space part.

8. The purge control solenoid valve apparatus for reducing noise as defined in claim 7, wherein the expansion space part is constituted by a plurality of expansion space portions divided by the plurality of partitions.
